(19) United States
(12) Patent Application Publication
(10) Pub. No.: US 2014/0164201 A1
(43) Pub. Date: Jun. 12, 2014

(54) Price Alignment Interest in Collateralized Financial Instruments

(71) Applicant: CHICAGO MERCANTILE EXCHANGE INC., Chicago, IL (US)

(72) Inventors: David Boberski, Westport, CT (US); John Wiley, New York, NY (US); John Nyhoff, Darien, IL (US); Jason Silverstein, Englewood, NJ (US); John Labuszewski, Westmont, IL (US)

(73) Assignee: Chicago Mercantile Exchange Inc., Chicago, IL (US)

(21) Appl. No.: 13/707,185

(22) Filed: Dec. 6, 2012

(51) Int. Cl. G06Q 40/04

(52) U.S. Cl. CPC G06Q 40/04
USPC 705/37

(57) ABSTRACT

A method for price alignment in a trade of a financial instrument between first and second market participants for whom first and second account records are maintained in a memory, respectively, and in which a mark-to-market loss is incurred and collateralized by the first market participant, includes determining, with a processor, an amount of an interest payment from the first market participant to the second market participant based on the mark-to-market loss, and accessing the memory to modify the first and second account records in accordance with the determined interest payment amount.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Although futures contracts generally confer an obligation to deliver an underlying asset on a specified delivery date, the actual underlying asset need not ever change hands. Instead, futures contracts may be settled in cash such that, to settle a future, the difference between a market price and a contract price is paid by one investor to the other. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract price.

By employing cash settlement, futures may be based on more abstract market indicators, such as stock indices, interest rates, futures contracts and other derivatives. Rather than requiring the delivery of a market index (a concept that has no real meaning), or delivery of the individual components that make up the index, at a set price on a given date, index futures can be settled in cash. The difference between the contract price and the price of the underlying asset (i.e., current value of market index) is exchanged between the investors to settle the contract.

Futures contracts are considered financial instruments for which there are no unrealized gains or losses during the term of the contract. Any gains or losses are realized in a mark-to-market (MTM) process on a daily basis and settled in cash. Market participants that have an unrealized loss or an unrealized gain are required to pay or collect, respectively, an amount corresponding to the value by which the contract has fluctuated on a settlement-to-settlement basis. Hence, there are effectively no unrealized gains or losses in a standard futures contract.

The daily payments are typically part of a risk management process, or margining mechanism, of the Exchange. In a typical MTM process, when one buys or sells a standard futures contract, that implies that both buyer (the holder of the long position) and seller (the holder of the short position) post an initial margin with the clearing house of the Exchange, and pay any subsequent losses or collect any subsequent profits daily and in cash.

The initial margin is often calculated to cover the maximum anticipated one day's price movement, from the closing or settlement price on one day to the closing or settlement price on the following day, with a high degree of probability, e.g., 95%, 97%, 99% probability. Subsequently, any losses or gains accumulating from the futures position are paid or collected, respectively, via the daily cash payments. This daily mark-to-market (MTM) process may also be referred to as the daily “pay and collect” process.

### BRIEF DESCRIPTION OF THE DRAWINGS

FIG. 1 depicts an illustrative computer network system that may be used to implement price alignment aspects of the disclosed embodiments.

FIG. 2 a block diagram of an exemplary implementation of the system of FIG. 1 for price alignment in accordance with the disclosed embodiments.

FIG. 3 depicts a flow chart showing operation of the system of

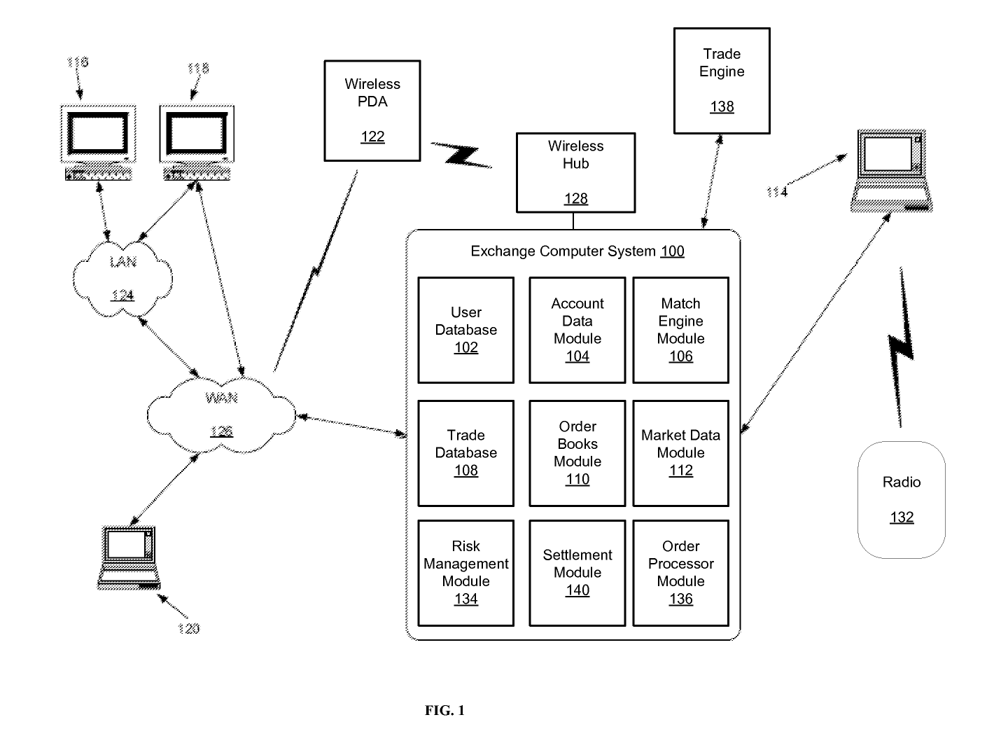

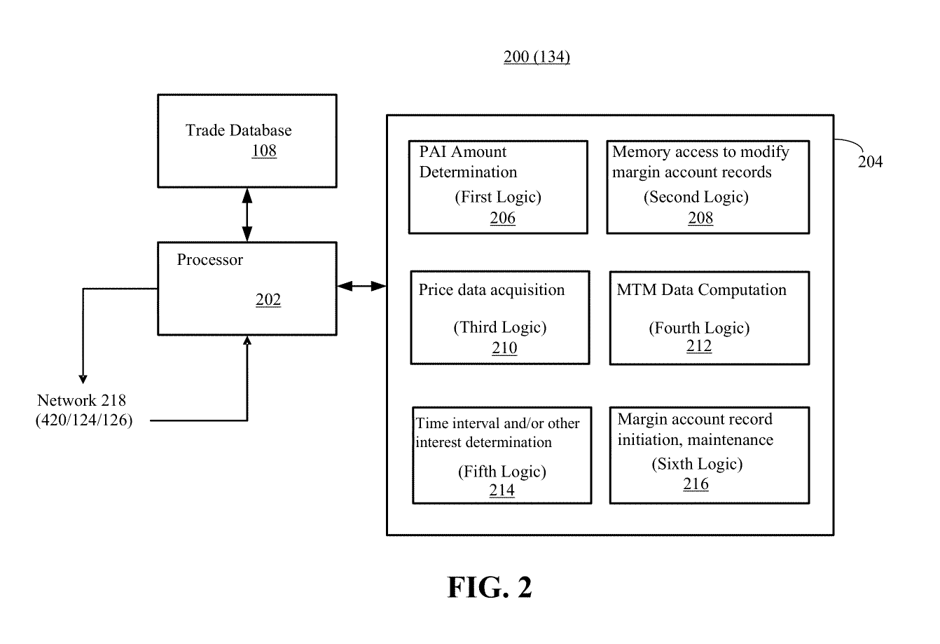

FIGS. 1 and 2.

FIG. 4 shows an illustrative embodiment of a general computer system for use with or in the system of FIGS. 1 and 2.

FIG. 5 shows an exemplary implementation of the disclosed embodiments.

### DETAILED DESCRIPTION

The disclosed embodiments relate to price alignment in connection with financial instruments for which mark-to-market (MTM) losses are collateralized. The disclosed systems and methods may allow the collateralization of daily MTM losses of futures and other contracts that may otherwise rely on cash margining mechanisms, while maintaining or matching the valuation or performance of such contracts. Any accumulation of unrealized losses is addressed via the price alignment techniques of the disclosed methods and systems. The price alignment techniques may allow the financial instrument to settle to a typical futures contract price. As described below, the price alignment techniques may include or involve interest payments designed to match the cash flows that occur in typical futures contracts. The use of a collateralized margining mechanism thus need not lead to divergent market valuations.

The disclosed methods and systems may support the use of a collateral-based margining mechanism rather than a cash-based MTM process. A collateral-based MTM approach may be useful because the daily settlements in cash-based margining are considered taxable events. Using collateral for daily settlements provides the market participants with increased flexibility in the realization of gains and losses for tax purposes. The increased flexibility is achieved without any detriment or deviation in valuation because the price alignment allows the instrument to settle to a price associated with cash-based MTM margining.

The price alignment techniques of the disclosed methods and systems may be useful for other reasons arising from supporting the use of collateral in the margining process. For example, the use of collateral may allow the gains and losses associated with the financial instrument to be considered ordinary income rather than capital gains or losses. The implementation of the price alignment techniques may thus lead to increases in the number or activity levels of certain market participants that may, for instance, otherwise be averse to realizing capital gains or losses. For example, certain types of investment entities prefer not to realize capital gains. Such entities may now be more interested in financial products and markets that economically behave like futures contracts (e.g., settle to a futures contract price with identical cash flows), yet retain the taxation and other characteristics of collateral-based margining.

The disclosed methods and systems may address challenges arising with collateralized MTM processes in which market participants that have accumulated unrealized losses do not pay those losses in cash (e.g., as in standard futures contracts that are marked to market daily and in cash). One result is that market participants that have accumulated unrealized gains are unable to invest or otherwise use those cash gains as in a standard futures contract. Another result is that those market participants with unrealized and collateralized losses continue to collect interest on the collateral posted with the clearing house to cover those unrealized losses. Market participants with unrealized gains are denied the opportunity to reinvest those gains at prevailing interest rates. These results may be avoided via implementation of the price alignment techniques of the disclosed methods and systems.

The price alignment techniques of the disclosed embodiments include or involve interest payment amounts calculated based on the mark-to-market losses incurred by one of the counterparties to a trade. In some embodiments, the interest payment amounts are calculated by reference to the prevailing federal funds or other rate. Market participants with unrealized gains are compensated via the interest payments. The valuation of the financial instruments may thus be aligned with similar instruments using cash margining mechanisms. The cash flows of a collateralized futures contract or other financial instrument may thus match those of a standard futures contract or other financial instrument using cash MTM methods.

The disclosed methods and systems provide the flexibility to use collateralized margining in futures contracts, swaps, and other financial instruments, regardless of whether such instruments may typically or otherwise use cash margining in other cases or contexts. Through the payment of price alignment interest, market participants may receive the benefits of gains that would otherwise be unrealized due to the use of collateralized margining mechanism. Collateralized futures contracts are only one example of a financial instrument that may be supported by implementing the price alignment techniques of the disclosed methods and systems.

The price alignment techniques of the disclosed methods and systems may be configured to reconcile the cash flows associated with a standard futures contract in which a daily MTM process is implemented in cash, with the cash flows associated with a futures contract in which daily MTM losses are collateralized. The collateralization of such losses may include depositing assets with the Clearing House or representative thereof, as opposed to delivering cash to the counterparty. The price alignment techniques of the disclosed methods and systems may be applied in the context of futures exchange products, where collateralizing the MTM losses associated with certain currency pairs may be useful in cases in which one currency is inconvertible.

In some embodiments, the disclosed methods and systems are useful in configuring a futures contract having (1) collateralization of the daily mark-to-market (MTM) as opposed to a cash MTM, coupled with (2) a daily payment and collection of price alignment interest (PAI) flowing from market participants that have accumulated unrealized losses to those with accumulated unrealized gains.

The price alignment techniques of the disclosed methods and systems are implemented in a manner that causes the interest payments to run from market participants with unrealized losses to those market participants with unrealized gains. The direction of the interest payments differs from other price alignment techniques in which the payments run in the opposite direction, i.e., from those market participants with unrealized gains to those with unrealized losses. Such price alignment interest (PAI) payments may be applied in connection with cleared over-the-counter (OTC) derivatives, e.g., interest rate swaps (IRS) products. In the context of OTC instruments, the PAI payments are directed to reconciling the cash flows of uncleared products and cleared products. Cleared IRS instruments involve cash MTM payments from those with unrealized losses to those with unrealized gains. But such cash payments differentiate cleared instruments from uncleared instruments, which typically involve MTM losses being collateralized. Thus, the PAI payments in the context of cleared OTC instruments run from those with unrealized gains to those with unrealized losses to reconcile the cash flows of cleared OTC instruments with the cash flows of uncleared OTC instruments. In contrast, the PAI payments in the disclosed methods and systems are administered to run in the reverse direction, i.e., from those with unrealized losses to those with unrealized gains.

The PAI techniques of the disclosed methods and systems may be incorporated into a risk management system and/or a margining mechanism or system of the Exchange. Alternatively or additionally, the disclosed methods and systems may be implemented as part of a separate or independent payment system or process.

In some embodiments, the disclosed methods and systems are implemented in a centralized processing system, such as one hosted by the Exchange. Alternatively, the disclosed embodiments may be implemented in a distributed fashion where a portion of the functionality may be implemented on a computer system of the market participant.

While the disclosed embodiments may be discussed in relation to trading in various futures contracts, it will be appreciated that the disclosed embodiments may be applicable to other financial instruments, such as interest rate swaps or other swaps. The financial instruments need not be referred to as “futures contracts” and may, in some cases, be referred to as swaps to distinguish the financial instruments from those relying on cash-based margining mechanisms. For example, the financial instruments to which the disclosed methods and systems may be applied may resemble a typical futures contract in one or more ways, but be referred to as a swap due to the use of a collateralized margining mechanism. The disclosed methods and systems may be used in connection with the trading of a wide variety of financial instruments, such as securities products, e.g., stocks or bonds, and over-the-counter (OTC) derivative products, e.g., interest rate swaps (IRS), credit default swaps (CDS), currency forwards, commodity swaps, equity swaps, etc. The disclosed methods and systems may be applied to many different equity, options, or futures trading system or other market now available or later developed where market participants may wish to collateralize unrealized losses during the term of the contract or instrument. For example, the disclosed methods and systems may be used in the context of various interest rate, currency, and physical commodity markets, such as agricultural markets.

It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the Exchange.

With reference now to the drawing figures, an exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange computer system 100 may be implemented with one or more mainframe, desktop or other computers, such as the computer 400 described below in connection with FIG. 4. A user database 102 may be provided which includes information identifying traders and other users of exchange computer system 100, such as account numbers or identifiers, user names and passwords. An account data module 104 may be provided which may process account information that may be used during trades.

A match engine module 106 may be included to match bid and offer prices and may be implemented with software that executes one or more algorithms for matching bids and offers. The match engine module 106 may be in communication with one or more of the local area network 124, the wide area network 126, or other elements of the exchange computer system 100 to receive data indicative of the orders from the market participants.

A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. The risk management module 134 may also be configured to determine risk assessments or exposure levels in connection with positions held by a market participant.

The risk management module 134 may be configured to administer, manage or maintain one or more margining mechanisms implemented by the exchange computer system 100. Such administration, management or maintenance may include managing a number of database records reflective of margin accounts of the market participants. In some embodiments, the risk management module 134 implements one or more aspects of the disclosed methods and systems in connection with such margin maintenance, including, for instance, the administration of price alignment interest computations and account transfers or modifications related thereto, as described below.

An order processing module 136 may be included to decompose delta-based and bulk order types for processing by the order book module 110 and/or the match engine module 106. The order processing module 136 may also be used to implement one or more procedures related to clearing an order.

In the example of FIG. 1, the exchange computer system 100 also includes a settlement module 140 (or settlement processor or other payment processor) to provide one or more functions related to settling or otherwise administering transactions cleared by the Exchange. Settlement-related functions need not be limited to actions or events occurring at the end of a contract term. For instance, in some embodiments, settlement-related functions may include or involve daily or other MTM settlements for margining purposes. For example, the settlement module 140 may be configured to communicate with the trade database 108 (or the memory(ies) on which the trade database 108 is stored) and/or to determine a payment amount based on a spot price, the price of the futures contract or other financial instrument, or other price data, at various times. The determination may be made at one or more points in time during the term of the financial instrument in connection with a margining mechanism. For example, the settlement module 140 may be used to determine a MTM amount on a daily basis during the term of the financial instrument. Such determinations may also be made on a settlement date for the financial instrument for the purposes of final settlement.

In some embodiments, the settlement module 140 may be integrated to any desired extent with one or more of the other modules or processors of the exchange computer system 100. For example, the settlement module 140 and the risk management module 134 may be integrated to any desired extent. In some cases, one or more margining procedures or other aspects of the margining mechanism(s) may be implemented by the settlement module 140.

The exchange computer system 100 may include one or more additional modules or processors, including, for instance, a volume control module configured to, among other things, control the rate of acceptance of mass quote messages. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122, which depict different exemplary methods or media by which a computer device may be coupled with the exchange computer system 100 or by which a user may communicate, e.g. send and receive trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may include a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to the exchange computer system 100. Moreover, the topology shown in FIG. 1 is merely an example and that the components shown in FIG. 1 may include other components not shown and be connected by numerous alternative topologies.

As shown in FIG. 1, the risk management module 134 and/or the settlement module 140 of the exchange computer system 100 may implement one or more aspects of the price alignment interest techniques of the disclosed methods and systems, as will be described with reference to FIG. 2. It will be appreciated the disclosed embodiments may be implemented as a different or separate module of the exchange computer system 100, or a separate computer system coupled with the exchange computer system 100 so as to have access to margin account record, pricing, and/or other data. As described above, the disclosed embodiments may be implemented as a centrally accessible system or as a distributed system, e.g., where some of the disclosed functions are performed by the computer systems of the market participants.

As described below in connection with the exemplary embodiments of FIGS. 2 and 5, one or more of the modules of the Exchange computer system 100 may be configured to implement price alignment in a trade of a financial instrument, such as a futures contract, between a pair of counterparties, which may be any type of market participants. The financial instrument trade is one in which a mark-to-market (MTM) loss is incurred and collateralized by one of the market participants. The module(s) of the Exchange computer system 100 are configured via, e.g., respective computer-readable instruction sets, as described below to (1) maintain respective account records, such as margin account records, in a memory (e.g., the user database 102, the trade database 108, and/or another database of the Exchange computer system 100) for the market participants involved in the trade, (2) determine an amount of an interest payment from the market participant incurring the MTM loss to the counterparty based on the MTM loss, and (3) access the memory to modify the first and second account records in accordance with the determined interest payment amount. In some cases, the account data module 104 (or other module(s) of the Exchange computer system 100) is used to access, update, and/or otherwise maintain the memory(ies) in which the account records are stored.

The account records may be or include margin account records. The margin or other account records may be stored or arranged in a database. The memory may include any number of memories or storage devices, and may be configured in a variety of different formats. The memory in which the account records are stored is thus not limited to a database or other particular format, configuration, data structure, or other data storage scheme or technique.

The transfer of the funds associated with the interest payments may be achieved or realized via various techniques. In some embodiments, the interest payments may be made via payments as described in co-pending and commonly assigned U.S. application Ser. No. 13/162,821, entitled “Facilitation of Payments between Counterparties by a Central Counterparty”, and filed Jun. 17, 2011, the entire disclosure of which is hereby incorporated by reference.

In some embodiments, the interest payment amount determination may be implemented via computer-readable instructions configured to determine an aggregate change in valuation of the financial instrument, and to determine the MTM loss based on the aggregate change in valuation. One or more of the above-described modules (or another module) may be configured with such instructions. The aggregation of valuation changes may simplify the computations and/or data storage of the Exchange computer system 100. For example, a database or other memory in which the account records are maintained may include only the aggregate or current state of the trade. A complete historical record for the trade may instead be maintained elsewhere, which may lead to increased processing speed and/or reduced hardware requirements (e.g., lower data storage requirements for frequently accessed memories).

In some embodiments, the account records are modified by the module(s) of the Exchange computer system 100 during a term of the financial instrument. The computer-readable instructions described herein may be implemented contemporaneously with other margin account computations during the pendency of the financial instrument. Implementing the computations during the contract term may allow the cash flows associated with the financial instrument to match those of an instrument, such as a standard futures contract, in which MTM losses are addressed via a cash-based margining mechanism (e.g., involving cash payments between the counterparties). The interest payment amount and other margin account computations of the Exchange computer system 100 may be implemented via common hardware (e.g., processor(s), memory(ies), etc.), which may lead to reduced hardware requirements. The combination of the various margin account computations may also simplify the transmission of the data resulting from such computations, thereby leading to reduced network or communication demands.

The processing demands presented by the risk management module 134 may be lowered as a result of implementing the disclosed interest payment techniques. For example, the interest payments may reduce or eliminate imbalances in cross-margining efforts between products with different types of margin methodologies. When cross-margining the different types of instruments, complex imbalances may be created both at the end of the day and inter-day. Addressing such mismatches may otherwise drain processing time and resources. With the interest payments of the disclosed methods and systems, one of the instruments may be effectively given the same margin methodology as the other instrument, thereby moving the instruments to the same basis to reduce mismatch and, thus, processing time.

The interest payment amount may be determined in accordance with one or more market rates. In one example, the interest payment amount may be determined in accordance with the Federal funds rate. Additional or alternative market rates may be used. The interest payment amount may be determined by applying the market rate(s) to the MTM loss for a given number of days, e.g., until the next trading session. Further details are provided below in connection with one or more examples.

One or more of the above-described modules of the Exchange computer system 100 may be used to gather or obtain data to support the interest payment amount determination. For example, the market data module 112 may be used to receive data indicative of a change in price of the financial instrument. The price change data may be based on a spot price of the market for the financial instrument. The price change may then be used in determining a value of the MTM loss. Further details regarding the implementation of the above-described modules are provided in connection with the example of FIG. 5.

FIG. 2 depicts a block diagram of a risk management module 134 (and/or settlement module 140 and/or other module) according to one embodiment, which in an exemplary implementation, is implemented as part of the exchange computer system 100 described above. As used herein, an Exchange supports the receipt, administration, management, and/or other processing of trades of financial instruments in which a MTM loss is incurred and collateralized by one of the parties to the trade. FIG. 2 shows a system 200 for price alignment in connection with such trades. The price alignment may reconcile the valuation of such collateralized financial instruments with those in which MTM losses are addressed via cash-based margin mechanisms. The system 200 may support the transfer of interest payments based on the MTM loss from a first market participant incurring the MTM loss to a second market participant. As the counterparty to the trade, the second market participant has a corresponding MTM or daily settlement benefit or gain.

The system 200 includes a processor 202 and a memory 204 coupled therewith which may be implemented as a processor 402 and memory 404 as described below with respect to FIG. 4. The system 200 further includes first logic 206 stored in the memory 204 and executable by the processor 202 to cause the processor 202 to determine an amount of an interest payment based on the MTM loss. The interest payment flows from the first market participant incurring the MTM loss to the second market participant, as described herein. The MTM loss may be an aggregate loss since the trade of the financial instrument. For example, the first logic 206 may be configured to cause the processor to determine an aggregate change in valuation of the financial instrument, and to determine the MTM loss based on the aggregate change in valuation. Further details regarding one or more examples of such determinations are provided below.

The system 200 further includes second logic 208 stored in the memory 204 and executable by the processor 202 to cause the processor 202 to access a database in which account records for the first and second market participants are stored. The account records may be margin account records, and the database may be a margin account database. In this embodiment, the database is or includes the trade database 108. Alternatively or additionally, the database is or includes the user database 102 (FIG. 1) or other database of the exchange computer system 100 (FIG. 1). The second logic 208 is configured to access the database to modify the account records of the first and second market participants in accordance with the interest payment amount determined by the first logic 206. The modification of the account records may be implemented during the term or pendency of the financial instrument, as described below.

In this embodiment, the system 200 further includes third logic 210 stored in the memory 204 and executable by the processor 202 to cause the processor 202 to acquire data indicative of a change in price of the financial instrument. The third logic 210 may be called during the implementation of the first logic 206 to support the PAI amount determination. The third logic 210 may, in turn, access or implement the market data module 112 (FIG. 1) or other component of the exchange computer system 100 (FIG. 1) to determine a market, spot, or other current price for the financial instrument. The price may then be used by the first logic 206 to determine the PAI amount. The third logic 210 may receive the price or other data indicative of the price change from a variety of sources.

In this embodiment, the system 200 further includes fourth logic 212 stored in the memory 204 and executable by the processor 202 to cause the processor 202 to determine a value of the MTM loss based on the data indicative of the change in price of the financial instrument. The fourth logic 212 may be called during the implementation of the first logic 206 to support the PAI amount determination. In some cases, the fourth logic 212 is configured to cause the processor 202 to determine an aggregate change in valuation of the financial instrument, and to determine the MTM loss based on the aggregate change in valuation. For example, the MTM loss may reflect the accumulation of unrealized losses and/or gains that have occurred to date for the financial instrument with each MTM or daily settlement. The MTM or daily settlement amounts may be summed to obtain a net amount to which the interest rate is then applied. Alternatively, the spot value of the financial instrument may be compared with the purchase price to determine a differential amount that corresponds with the aggregate change in price. The aggregate change may be used to support the computation and transfer of the interest payment amount on a daily or other periodic basis during the term or pendency of the financial instrument.

The system 200 may also be configured to compute the interest payment amount based on a time interval until a subsequent business day. In this embodiment, the interest payment amount computation is implemented by fifth logic 214 called by the fourth logic 212 (and/or the first logic 206). The fifth logic 214 is stored in the memory 204 and executable by the processor 202 to cause the processor 202 to determine the time interval by applying an interest rate to the MTM loss and then scaling the result by a scaling factor based on the length of the time interval. For example, if the MTM loss is incurred on a day followed by another business day (e.g., one in which trading occurs), then the time interval is one day. If the interest rate selected for the computation is based on a full calendar year, then the scaling factor is 1/365. The interest rate may be based on a different annual time period, such as 360 days. If the MTM loss is incurred on a Friday or other day followed by a non-business day (e.g., one in which trading does not occur), then the time interval is either two or more days. When the time interval involves a weekend, the time interval is three days, and the scaling factor may be 3/365.

The third logic 210, the fourth logic 212, and/or the fifth logic 214 may be integrated with one another and/or the first logic 206 to any desired extent.

In this embodiment, the system 200 further includes sixth logic 216 stored in the memory 204 and executable by the processor 202 to cause the processor 202 to initiate (e.g., create or instantiate) and/or maintain margin account records for the market participants to facilitate and support the PAI techniques described herein. The margin account records may be created or otherwise initiated in a database, such as one or more of the databases described herein. The sixth logic 216 may be called during the implementation of the second logic 208 in connection with the modification of the margin account records in accordance with the PAI amount. In some embodiments, the sixth logic 216 may correspond or be associated with the account data module 104 (FIG. 1) or other module of the exchange computer system (FIG. 1) configured to manage or access one or more of the databases thereof.

Data indicative of any of the intermediate or final results of the above-described processing and price alignment techniques may be stored in the trade database 108, the memory 204, or other database or memory of the system 200 or the exchange computer system 100 (FIG. 1). Data indicative of the price alignment techniques may be transferred to the market participants via the network 218 or any of the other communications links described herein. Such communication links may also be used to obtain data indicative of price changes and/or other data used during implementation of the price alignment techniques. For example, the network 218 may be used to receive data indicative of a change in price of the financial instrument to support the determination of the MTM loss.

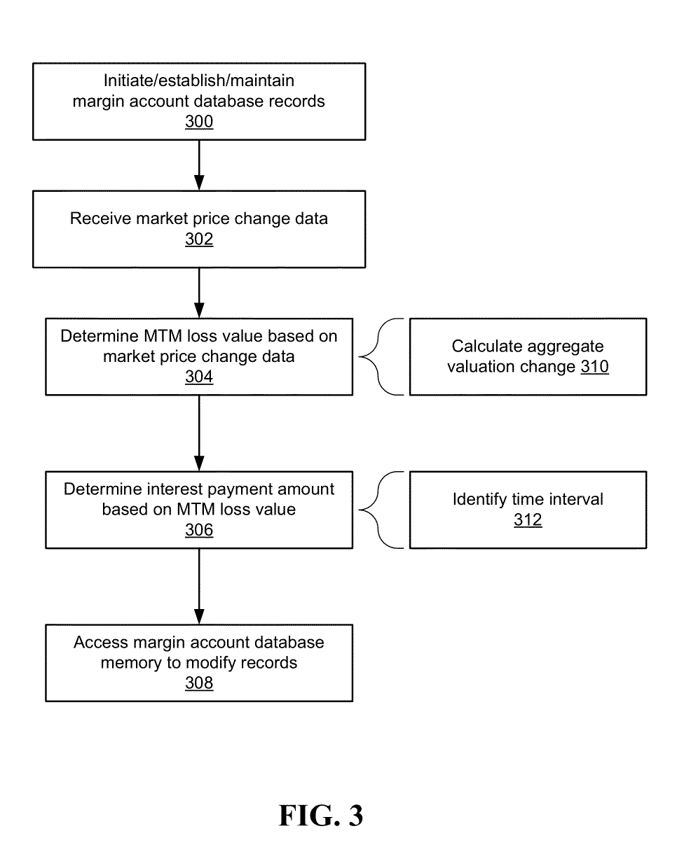

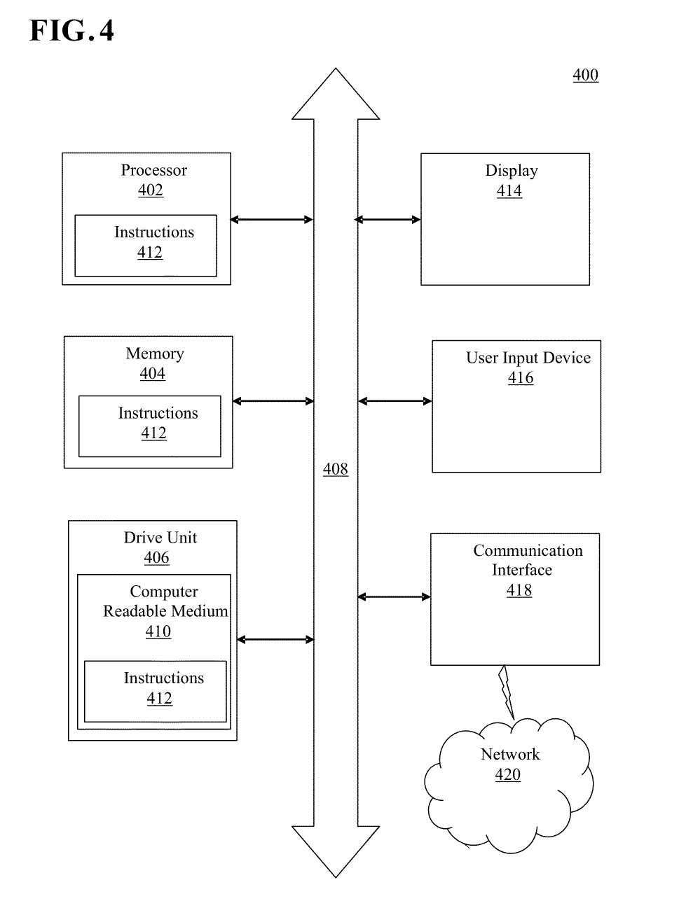

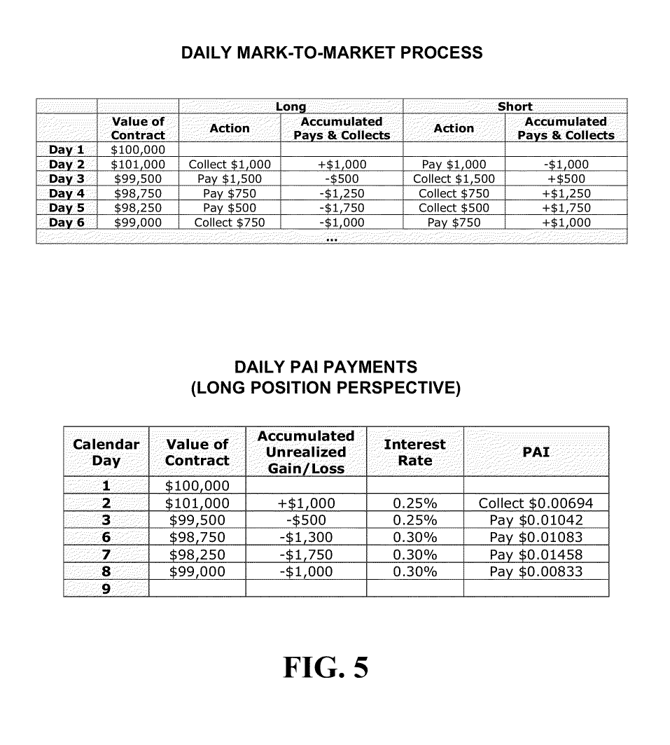

FIG. 3 depicts a flow chart showing operation of the system 200 of FIG. 2. In particular FIG. 3 shows a computer-implemented method for price alignment in a trade of a financial instrument between first and second market participants for whom respective accounts are maintained in a memory. The price alignment is directed to addressing a MTM loss incurred and collateralized by the first market participant. The operation of the system 200 includes: initiating, establishing, or otherwise maintaining margin account database records in the memory [block 300]; receiving market price change data [block 302]; determining a value of a MTM loss incurred by the first market participant based on the market price change data [block 304]; determining an amount of an interest payment from the first market participant to the second market participant based on the MTM loss value [block 306]; and accessing the memory in which the margin account database are stored to modify the records in accordance with the determined interest payment amount [block 308].

In some embodiments, the MTM loss value determination includes calculating or otherwise determining an aggregate or net change in valuation of the financial instrument [block 310]. The MTM loss may then be determined based on the aggregate or net change in valuation. For example, the MTM loss may then be an aggregate or net loss since the trade of the financial instrument. The aggregate or net change in valuation may be determined by comparing the current market price with the price of the financial instrument at which the trade was made. Other calculations may involve or include daily or other periodic computations to track the valuation changes over time.

In some embodiments, the interest payment amount determination includes identifying a time interval to be used in determining the interest payment amount [block 312]. For example, the time interval may be the number of days until the subsequent business day. The interest payment amount may then be computed based on the identified time interval.

The steps or blocks of the above-described method may be implemented during the term or pendency of the financial instrument. For example, the interest payment amount may be determined, and the account database records modified, during the term of the financial instrument. In some cases, the interest payment amount determinations and the account modifications are implemented each business day (or otherwise periodically). The cash flows during the term of the financial instrument may thus match those financial instruments using cash MTM margining techniques. In embodiments in which the financial instrument is configured as a collateralized futures contract, the cash flow of the financial instrument may match the performance of a standard, cash MTM futures contract.

In alternative embodiments, the account records of the market participants are not margin accounts. The interest payment amounts may be transferred to or between other types of accounts associated with the market participants, or a representative or agent thereof, such as a prime broker.

The blocks of the above-described method may be implemented in an order other than as shown. For example, the maintenance of the margin account database records may be implemented or initiated after or concurrently with the receipt of the market price change data. Additional, fewer, or alternative blocks may be implemented. For example, the method need not include a separate step or block in which the margin account database records are accessed or maintained.

One or more modules described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an exchange system 100 for financial instruments.

Referring to FIG. 4, an illustrative embodiment of a general computer system 400 is shown. The computer system 400 can include a set of instructions that can be executed to cause the computer system 400 to perform any one or more of the methods or computer-based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, order processing, margining, and/or other function on behalf of an Exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Implementation of the disclosed methods and systems is not limited to applications in which actual trading is occurring. The price alignment techniques may be implemented as part of a simulated trading environment. For example, the collateralized margining process may be simulated to show “what if” results according to various combinations of bids and/or positions. The results may be provided to a market participant as feedback in preparation for an actual trading session. The above-described processing systems may be useful for executing large number of such simulated environments to provide market participants with data or information leading up to, or during, the actual trading session. The market participants may use such information to determine maximum order amounts, customize maximum net risk exposure levels, or otherwise prepare for the trading session.

As described above, one or more aspects of the disclosed methods and systems may be directed to creating a futures contract or other financial instrument in which daily settlement-to-settlement fluctuation in price is collateralized rather than paid and collected in cash. Each daily MTM loss is covered by collateral, such as fixed income securities or other assets. For example, the clearing house of the Exchange may designate certain types of assets as acceptable or good collateral.

The disclosed methods and systems may address the effects of collateralization of MTM losses. Without the price alignment interest payments of the disclosed methods and system, market participants accumulating unrealized losses are advantaged to the extent that they can continue to earn interest on the posted collateral, and market participants accumulating unrealized gains are otherwise disadvantaged to the extent that they are denied the opportunity to earn interest on the cash that they would otherwise receive if the MTM loss were not collateralized but were paid in cash (e.g., as in a standard futures contract). The price alignment interest is paid by market participants with accumulated unrealized losses. The interest may be passed through the clearing house to the accounts of market participants (or the representatives thereof) with accumulated unrealized gains. The price alignment interest may thereby reconcile the cash flows of a collateralized futures contract with the cash flows of a standard futures contract in which cash-based MTM margining occurs.

FIG. 5 provides an exemplary implementation of one embodiment of the disclosed methods and systems for price alignment in a trade of a financial instrument, such as a futures contract or swap, in which MTM losses are collateralized. The example is provided within the context of futures contracts with the understanding that the disclosed methods and systems are well suited for other markets, financial instruments, and contexts.

A first table of FIG. 5 entitled “Daily Mark-to-Market Process” depicts an example of cash-based MTM margining. In this example, a market participant purchases a futures contract (e.g., the long position) for $100,000. The value of the futures contract then appreciates to $101,000 by the following day. In a typical futures contract using cash-based margining, this price change implies that the market participant holding the short position (the counterparty) pays $1,000 to the clearing house, which in turn passes that value to the account of the market participant holding the long position. On Day 3, the value of the futures contract declines to $99,500 or a decline of −$1,500. Thus, in cash-based margining, the holder of the long position pays $1,500 to the clearing house, which in turn passes that value to the account of the holder of the short position. This process continues until one of the market participants offsets the contract or the futures contract matures and is either cash settled or calls for a physical delivery of the underlying commodity, product, or instrument.

As a result of the above-described daily cash transfers, there are effectively no accumulated unrealized gains or losses associated with holding a futures position. Because the cash is paid and collected on a daily basis, market participants with accumulated unrealized gains are free to reinvest those gains at prevailing short-term interest rates. Similarly, market participants with accumulated unrealized losses are denied use of the cash and therefore implicitly forfeit the opportunity to invest such cash at prevailing short-term interest rates.

The disclosed methods and systems support the collateralization of the MTM gains or losses rather than require payments in cash. As described herein, it may be convenient or otherwise useful to administer such flows with the use of collateral rather than cash. Such collateralization of the unrealized MTM gains and losses is then supported via the price alignment interest payments determined and facilitated by the disclosed methods and systems. Market participants with unrealized losses may thus post collateral with, e.g., the clearing house, valued, at a minimum, at the amount of the accumulated unrealized losses. Market participants with unrealized gains do not own that collateral but are assured that such collateral is available to be applied by the clearing house to make good on those unrealized gains in the event that market participant with unrealized losses does not pay in cash upon liquidation of his position.

Such collateralization process may be useful in the context of currency or foreign currency exchange (FX) futures in which one of the currencies referenced in the contract is inconvertible. For example, such inconvertibility may be an issue in a futures contract based upon the exchange rate between the Indian rupee (INR) and the U.S. dollar (USD). While the USD is freely convertible, exchange of INR for capital or current account application is strictly controlled by the Indian central bank. The USD-INR exchange rate is typically quoted in INR per USD in interbank FX markets. This practice implies that a futures contract might be quoted in INR and USD and, accordingly, the daily MTM amounts may be calculated and administered in INR. But because INR is generally inconvertible for these purposes, it may be more convenient to collateralize the accumulated unrealized gains and losses in USD denominated collateral.

While a collateralization process may address the difficulties of administering a daily MTM margining mechanism in an inconvertible currency, collateralization alone does not reconcile the cash flows of a collateralized futures contract with a standard futures contract that is marked-to-market daily and in cash.

The second table shown in FIG. 5 entitled “Daily PAI Payments (Long Position Perspective)” depicts the use of price alignment interest (PAI) to reconcile the cash flows of a collateralized futures contract with a standard futures contract. The collateralization of the MTM losses is applied to the same valuation changes shown in the table entitled “Daily Mark-to-Market Process.” When either of the market participants accumulates an unrealized loss, the market participant posts collateral to cover the loss. For example, at the end of Day 2, the holder of the short position posts collateral of at least $1000 in value. Thus, the holder of the short position remains able to collect interest on that collateral. The holder of the long position, i.e., the counterparty with an accumulated unrealized gain, is unable to apply that $1000 in interest bearing securities. Thus, the cash flows associated with a collateralized futures contract depart from those associated with a standard futures featuring a daily MTM in cash.

The example shown in FIG. 5 depicts the manner in which the PAI payments are configured to reconcile the cash flows of a collateralized futures contract with those of a standard futures contract where the daily MTM is paid and collected in cash. In this example, market participants who have accumulated unrealized losses are required to pay interest daily to the clearing house, which, in turn, passes the payments on to the accounts of the market participants who have accumulated unrealized gains. In this embodiment, the PAI amount is determined based upon the accumulated unrealized gain or loss. For example, each PAI amount is based upon the aggregate or net unrealized gain or loss since the purchase of the contract. The PAI amount may then be calculated based upon a prevailing interest rate, such as the effective Fed Funds rate, LIBOR rates, etc., and upon the number of days between the current date and the next business day (e.g., the time interval). In this example, the interest rate is configured with a 360 day annual day count. Other day count conventions may be applied as appropriate. The PAI amount may thus be determined as follows:

PAI=Interest Rate×(time interval/360)×Unrealized Balance.

In the example shown in FIG. 5, the account of the holder of the long position has an unrealized loss of $1,750 at the end of Day 7. If there is one day between Day 7 and the subsequent business day, and if the interest rate is at 0.30%, the daily PAI amount to be transferred may be calculated as $0.01458 (PAI=0.30%×(1/360)×$1,750=$0.01458).

FIG. 5 also depicts the PAI determination a multiple calendar day gap to illustrate the impact of a weekend (Days 4 and 5). At the end of Day 3, the holder of the long position has accumulated a loss of $500. With the interest rate at 0.25%, and with three days until the next business day (i.e., Day 6), the PAI amount may be determined as follows: PAI=0.25%×(3/360)×$500=$0.01042. In contrast, at the end of Day 6 (i.e., Monday), the holder of the long position has accumulated a loss of $1300, which leads to a PAI amount as follows: PAI=0.30%×(1/360) $1300=$0.01083. In an alternative embodiment, the impact of a weekend may be addressed differently, with the computation for Monday reflecting the multiple calendar day gap. The disclosed methods and systems may address multiple calendar day gaps in accordance with the day count convention of the financial instrument with which the PAI techniques are attempting to align.

The transfer of the PAI amounts may be directed to replicating the cash flows associated with a contract marked-to-market daily and in cash. The direction of the PAI amounts are reversed from the interest payments made in the context of cleared over the counter (OTC) instruments. PAI payments in the context of cleared OTC instruments are intended to replicate the cash flows associated with a collateralized and uncleared OTC instrument. For example, the CME Group Clearing House offers clearing services in the context of interest rate swaps (IRS) and other OTC instruments. Such uncleared OTC instruments may generally utilize a collateralization process. In contrast, cleared OTC instruments are typically marked-to-market daily and in cash, akin to a standard futures contract. As such, the cash flows associated with uncleared and cleared OTC instruments may diverge. In order to reconcile the cash flows of a cleared OTC instrument marked-to-market in cash with those of an uncleared OTC instrument where unrealized gains and losses are collateralized, holders of cleared OTC market participants with unrealized gains are required to pay interest to market participants with unrealized losses.

In the disclosed methods and systems, the direction of the PAI flows are reversed. The PAI payments run from those with unrealized losses to those with unrealized gains. The PAI amounts are thus directed to addressing a different purpose in the context of collateralized futures contracts and other financial instruments. The PAI amounts of the disclosed methods and systems (e.g., applied in the context of collateralized futures contracts) may be considered to be configured as an “inverse” or “reverse” PAI flow, as described herein.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for price alignment in a trade of a financial instrument between first and second market participants for whom first and second account records are maintained in a memory, respectively, and in which a mark-to-market loss is incurred and collateralized by the first market participant, the method comprising:
determining, with a processor, an amount of an interest payment from the first market participant to the second market participant based on the mark-to-market loss; and
accessing the memory to modify the first and second account records in accordance with the determined interest payment amount.

2. The computer implemented method of claim 1 wherein determining the interest payment amount comprises computing, with the processor, the interest payment amount based on a time interval until a subsequent business day.

3. The computer implemented method of claim 1 wherein determining the interest payment amount comprises:
determining an aggregate change in valuation of the financial instrument; and
determining the mark-to-market loss based on the aggregate change in valuation.

4. The computer implemented method of claim 1 wherein the mark-to-market loss is an aggregate loss since the trade of the financial instrument.

5. The computer implemented method of claim 1 wherein the first and second account records are modified during a term of the financial instrument.

6. The computer implemented method of claim 1 wherein determining the interest payment amount and accessing the memory to modify the first and second account records are implemented each business day.

7. The computer implemented method of claim 1 further comprising maintaining a margin account database in the memory, the margin account database comprising the first and second account records.

8. The computer implemented method of claim 1 further comprising:
receiving data indicative of a change in price of the financial instrument; and
determining, with the processor, a value of the market-to-market loss based on the data indicative of the change in price of the financial instrument.

9. The computer implemented method of claim 1 wherein the financial instrument comprises a futures contract.

10. A system for price alignment in a trade of a financial instrument between first and second market participants for whom first and second account records are maintained in a margin account database, respectively, and in which a mark-to-market loss is incurred and collateralized by the first market participant, the system comprising a processor and a memory coupled with the processor, the system further comprising:
first logic stored in the memory and executable by the processor to determine an amount of an interest payment from the first market participant to the second market participant based on the mark-to-market loss; and
second logic stored in the memory and executable by the processor to access the margin account database to modify the first and second account records in accordance with the determined interest payment amount.

11. The system of claim 10 wherein the first logic is further executable by the processor to cause the processor to compute the interest payment amount based on a time interval until a subsequent business day.

12. The system of claim 10 wherein the first logic is further executable by the processor to cause the processor to determine an aggregate change in valuation of the financial instrument, and to determine the mark-to-market loss based on the aggregate change in valuation.

13. The system of claim 10 wherein the mark-to-market loss is an aggregate loss since the trade of the financial instrument.

14. The system of claim 10 wherein first and second account records are modified during a term of the financial instrument.

15. The system of claim 10 further comprising:
third logic stored in the memory and executable by the processor to receive data indicative of a change in price of the financial instrument; and
fourth logic to determine a value of the market-to-market loss based on the data indicative of the change in price of the financial instrument.

16. A system for price alignment in a trade of a financial instrument between first and second market participants, and in which a mark-to-market loss is incurred and collateralized by the first market participant, the system comprising:
means for maintaining first and second account records in a memory for the first and second market participants, respectively;
means for determining an amount of an interest payment from the first market participant to the second market participant based on the mark-to-market loss; and
means for accessing the memory to modify the first and second account records in accordance with the determined interest payment amount.

17. The system of claim 16 wherein means for determining the interest payment amount comprises means for determining an aggregate change in valuation of the financial instrument, and means for determining the mark-to-market loss based on the aggregate change in valuation

18. The system of claim 17 wherein the first and second account records are modified during a term of the financial instrument.

19. The system of claim 17 wherein the means for maintaining the account records comprises means for maintaining a margin account database in the memory, the margin account database comprising the first and second account records.

20. The system of claim 17 further comprising:
means for receiving data indicative of a change in price of the financial instrument; and
means for determining a value of the market-to-market loss based on the data indicative of the change in price of the financial instrument.
